(19) United States
(12) Patent Application Publication
(10) Pub. No.: US 2011/0036222 A1
(43) Pub. Date: Feb. 17, 2011

(54) FOIL MEASURER WITH SUCTION CHAMBER

(75) Inventor: Reinhard Raueiser, Muden (DE)

Correspondence Address: OSHA LIANG L.L.P., TWO HOUSTON CENTER, 909 FANNIN, SUITE 3500, HOUSTON, TX, 77010, US

(73) Assignee: WINKLER + DUENNEBIER AG, Neuwied (DE)

(21) Appl. No.: 12/838,140

(22) Filed: Jul. 16, 2010

(30) Foreign Application Priority Data
Jul. 16, 2009 (DE) 10 2009 033 575.7

(51) Int. Cl. B26D 7/18

(52) U.S. Cl. 83/100

(57) ABSTRACT

A foil knife for utilization on a surface area of a suction roller includes at least one blade and a base plate with a surface that features in a snips area, which faces a snip detached during a cutting process from a useful part of a sheet material, at least one suction air through-passage for holding the snip by means of a suction effect through a predetermined angle range of a rotation of a suction roller on the same. The foil knife features around the suction air through-passage at least one plateau area in which the foil knife is elevated, at least section wise, relative to the thickness of the base plate by a height, as measured from the surface of the base plate, wherein this height is smaller than the height, measured from the surface of the base plate, of the blade of the foil knife.

### AREA OF APPLICATION

The invention concerns foil knifes that are disposed on the surface area of a vacuum roller for the purpose of processing or cutting of sheet material pieces, and in particular a foil knife whereby the snips detached by means of the cut from the sheet material are held by means of a suction effect on the surface of the foil knife through a certain rotation angle of the vacuum roller.

### TECHNICAL BACKGROUND

During the rotational processing of sheet material pieces, such as for example the manufacture of letter envelopes, the sheet material pieces to be processed can, among other things, be transported and/or be processed by means of vacuum rollers. By means of the suction holes in the surface area of the vacuum roller, which are supplied with vacuum by means of suction channels running axially within the vacuum roller, the sheet material is thereby held to the surface area of the vacuum roller.

In the case that the sheet material piece is to be cut to size in a rotational process for example to a desired contour or is to be cut out of the interior area of the sheet material piece, such as for example the window opening in a letter envelope, a so-called foil knife can be put for this purpose on the surface area of the vacuum roller. This foil knife can be provided hereby in the form of a plate with blades projecting in the radial direction of the roller and can be held for example by means of magnetic force to the surface area of the roller.

The sheet material to be cut is likewise held by means of suction created by vacuum, however at the surface of the foil knife, which for this purpose features suction air through-passages that are essentially flush with the suction holes in the surface area of the roller.

A corresponding foil knife is for example described in DE 199 25 612 A1.

The waste sections (to be called snips in what follows) detached during the cut from the useful part of the sheet material that is to be further processed, meaning the edge sections surrounding the useful contour or the area within the cut window opening, can hereby after the cut still be transported, while abutting, by means of the suction effect at the surface of the foil knife over a certain angle range of the rotation of the vacuum roller after the cut to then, in a controlled manner, be disposed/blown off by means of terminating the suction effect and/or impingement of the suction holes with pressurized air for the purpose of disposal from the vacuum roller.

Due to the normally small size of the snips the suction air through-passages of the foil knife that hold the snips after the cut are disposed in the immediate vicinity of the blades of the foil knife. Among other things the result is that the snips cannot be drawn to the base of the foil knife, with the result that a certain loss in vacuum is created because surrounding air can enter between snips and foil knife surface. This loss of vacuum can then in the end lead also to an uncontrolled detachment of the snip from the surface of the foil knife.

An uncontrolled detachment of the snip from the surface of the foil knife during the rotation of the vacuum roller is however highly undesired because the freely movable snip can fly around in an uncontrolled manner in the processing machine and can lead to interferences with the processing of the sheet material pieces and, in the worst case, to damage of the installation.

The aforementioned problem arises in particular in those circumstances when a sheet material blank is subject to a so-called full-width cut, in the case of which, because of the cut contour at the corners of the sheet material piece particularly small corner snips are generated that have no further connection with the sheet material blank and are therefore held on only by means of the suction air. Such corner snips have a particular tendency to detach themselves from the roller at high rotation velocities.

### DISCLOSURE OF THE INVENTION

a) Technical Problem

It is therefore the object of the invention at issue to create a foil knife for the utilization with a vacuum roller whereby an uncontrolled, unregulated detachment of snips is avoided and therefore a secure transport of snips until the prescribed detachment position is assured.

b) Solution of the Problem

This object is met according to the characteristics of claim 1. Advantageous embodiments are specified in the sub claims.

The foil knife according to the invention is intended for utilization on a surface area of a suction roller and features at least one blade as well as a base plate with a surface. The surface of the base plate encompasses hereby in a “snips area”, meaning that area that faces a snip detached during a cutting process from a useful part of a sheet material, at least one suction air through-passage. Due to this suction air through-passage the snips can, by means of a suction effect, be held over the course of a prescribed angle range of the rotation of the suction roller to the same. According to the invention the foil knife features at least one plateau area around the suction air through-passage. In this plateau area the foil knife is implemented relative to the thickness D of the base plate of the foil knife at least section wise elevated by a height h measured from the surface of the base plate.

The height h in so doing is smaller than the height H of the blade of the foil knife measured from the surface of the base plate.

Due to the presence of the plateau area it is no longer necessary that the snip are pulled up to abutment to the surface of the foil knife because it reaches a seating arrangement on the plateau area earlier.

Preferably the plateau area surrounds the suction air through-passage completely in order to assure an even abutment of the snip around the suction air through-passage. It is however also conceivable that the plateau area surrounds the suction air through-passage only section wise. The even or, if necessary, symmetric arrangement of several plateau areas around the suction air through-passage is also possible. It is however not stringently necessary that the plateau area(s) are disposed across the entire angle range of 360° around the suction air through-passage.

In a preferred embodiment the foil knife is implemented in the plateau area in a continuous manner elevated by a height h measured from the surface of the base plate. In the case where several plateau areas are disposed around the suction air through-passage, they are preferably implemented in such a manner that the foil knife is, in a continuous manner, elevated in all plateau areas by a height h measured from the surface of the base plate. Fundamentally it could be conceivable, particularly in the case of several plateau areas, that these would be implemented in a manner such that the foil knifes in the respective plateau areas are implemented elevated in a continuous manner by different heights h₁, h₂, . . . hₓ that are measured from the surface of the base plate.

Of course it would also be possible in the context of the invention to implement the plateau area(s) in such a manner that the foil knife is implemented elevated by different heights hₐ, h_{b}, h_{c} that are measured from the surface of the base plate, meaning the foil knife features within the plateau area(s) no even height in a continuous manner.

Preferably the plateau area is spaced apart from the suction air through-passage at least section-wise. This has the advantage that in the areas between the edges of the suction air through-passage and the plateau area a suction chamber can be formed so that the suction area impinged with vacuum and provided with suction effect is enlarged. Preferably in this case the suction air through-passage is completely and continuously surrounded by the plateau area so that laterally no infiltrated air can be pulled into the suction chamber.

In its simplest form the plateau area can be implemented as a bar. As bar an elevated form is hereby understood, in the context of the invention at issue, that distinguishes itself through a significantly diminished transverse extent in comparison to the longitudinal extent. In this context it does not have to entail a linear bar. Rather the bar-shaped plateau area can extend in a curved, circular or any other form. Furthermore the bar does not have to feature an even width, meaning transverse extent, over its entire longitudinal extent. Also a bifurcation of a bar into two partial bars or something similar can be contemplated. Furthermore the bar could not be implemented in a continuous manner but feature breaks.

In particular the plateau area that is implemented as a bar can feature a width, as measured at the base plate, that is smaller than the width of the blades as measured at the base plate. The bar-shaped plateau area could also project, starting from the base plate, in a tapering manner, meaning it could feature in this sense a conical cross section.

The plateau area can furthermore, on its side facing away from the base plate, feature at least one plateau area blade. By means of the implementation of a plateau area blade on the plateau area a better seal between snip and plateau area can be achieved because of the cutting engagement into the snip of the plateau area blade that is implemented on the plateau area. This is particularly of an advantage when the plateau area is utilized for the implementation of a suction chamber around the suction air through-passage, since because of the better sealing a smaller infiltrated air portion can enter so that the suction effect is improved.

It is obvious that the plateau area blade should be dimensioned in such a manner that, in the case of an abutment of the snip to the plateau area, a complete cut of the snip is not accomplished. Consequently the height of the plateau area blade, measured from the surface of the base plate of the foil knife, will typically be smaller than the height H of the foil knife blade.

It could however for example also be conceivable that the plateau area blade features a height, measured from the surface of the base plate of the foil knife, that corresponds to the height of the foil knife blades. In so doing the plateau area blade is however not implemented continuously but features breaks or areas of lower height so that in the case of an abutment of the snip to the plateau area a complete cut of the snip is not accomplished but instead a section wise cut in the sense of a perforation is implemented.

In other words the height of the plateau area blade, measured from the surface of the base plate of the foil knife, is in this case at least section wise smaller than height of the blade of the foil knife, measured from the surface of the base plate of the foil knife.

Preferably in the case of the foil knife according to the invention the difference between the height H of the blades of the foil knife and the height h of the plateau area corresponds essentially to the thickness of the sheet material to be cut. This has the advantage that the snip abuts essentially from the start to the plateau area and does not have to be brought to abutment against the plateau area only by means of the suction effect of the suction air through-passage.

In the snips area several suction air through-passages can of course be present in the base plate of the foil knife, wherein then preferably around each of the suction air through-passages at least one plateau area is disposed. Advantageously in this case at least two of the suction air through-passages that are present in the snips area are surrounded by a common plateau area so that, if necessary, a common suction chamber can be implemented. Preferably the common plateau area then surrounds the suction air through-passages respectively completely.

In order to assure an effective implementation of a suction chamber and/or an abutment of the snip against the plateau area, the plateau area can furthermore extend at least section wise up to the blade that detaches the snip from the useful part of the sheet material.

It is also advantageous if the outer contour of the plateau area corresponds essentially to the outer contour of the snip, since then the snip comes in contact especially at the critical locations, meaning its edges, with the plateau area.

### EMBODIMENT EXAMPLES

An embodiment of the invention is described by example in what follows based on the figures.

The drawings show:

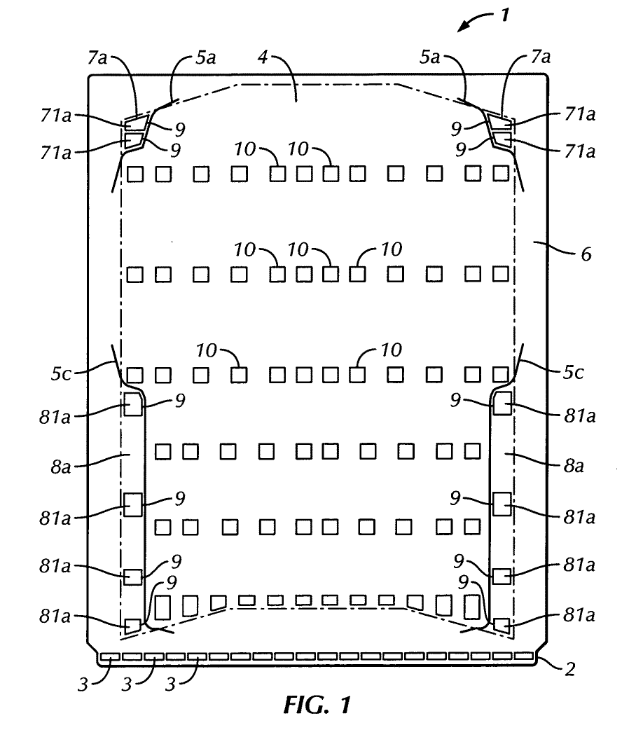

FIG. 1 a view onto an embodiment of a foil knife according to the invention that is not disposed on an associated suction roller but is in a planar rolled-off state;

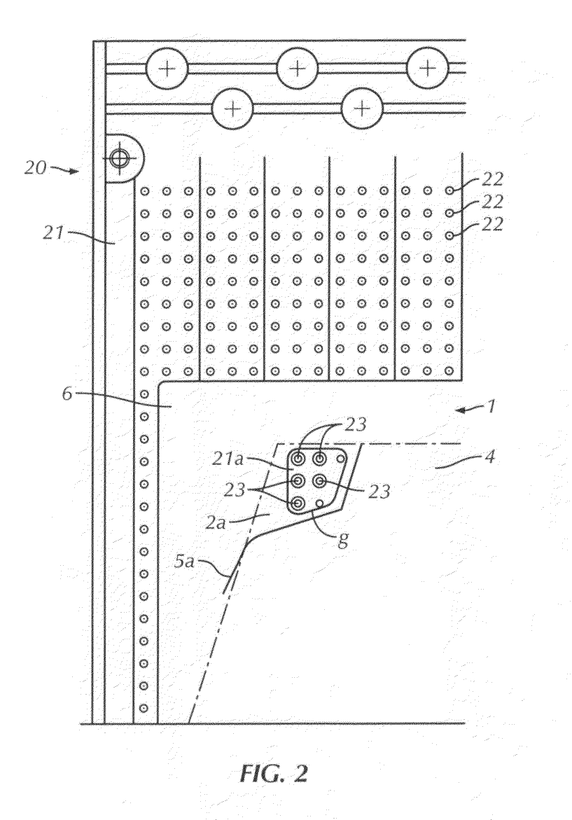

FIG. 2 a schematic partial view of a further embodiment of a foil knife according to the invention that is disposed on a suction roller, and

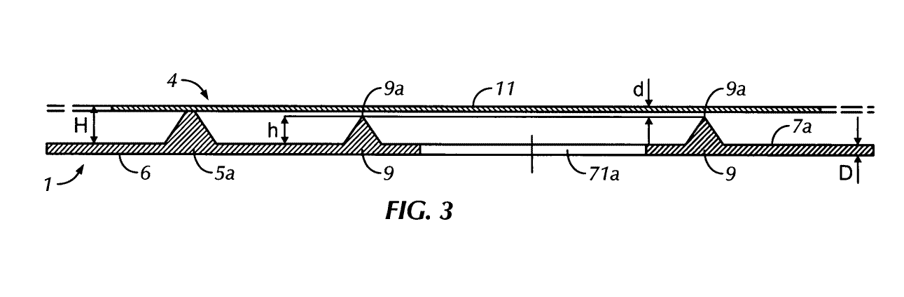

FIG. 3 a cross section view of an embodiment of a foil knife according to the invention with a snip disposed on the foil knife.

In the following figure description different embodiments of the foil knife according to the invention are described. For reasons of simplicity components that correspond in regard to their function are provided in the individual figures with the same reference symbols.

FIG. 1 presents a first embodiment of a foil knife 1 according to the invention. The foil knife 1 is hereby represented in a planar state, having been rolled-off a corresponding suction roller. The foil knife features, on its front end 2 seen in the rotation direction of the roller, a row of elongated passage openings 3 that serve the purpose to immobilize the foil knife 1, with the aid of pins that engage into the passage openings 3, on the surface area of a suction roller in the axial direction as well as in the circumferential direction in reference to the suction roller in a predefined position. The foil knife 1 can for example be fixed with the aid of magnetic exchange interaction to the surface area of the suction roller.

Furthermore the outer extent of an envelope blank 4 to be cut by the foil knife is represented in FIG. 1 by means of a circumferentially running dashed line. The foil knife 1 features for the purpose of the cutting of the envelope blank 4 four blades 5a, 5b, 5c and 5d that are spatially separated from one another and that respectively project from the surface of the base plate 6 of the foil knife 1, for example in the form of essentially equilateral triangles.

By means of the blades 5a, 5b, 5c and 5d a total of four small snips are detached from the envelope blank 4 during the application of the foil knife. The two large snips lie in so doing in the front area, as seen in the rotational direction of the roller, of the cut 4 while the two smaller snips are disposed in the backward area of the blank 4.

Facing the snips respectively the foil knife 1 features snips areas 7a, 7b or 8a and 8b. Within these snips areas 7a, 7b, 8a and 8b respectively several suction air through-passages 71a, 71b, 81a or 81b are disposed in the base plate 1a of the foil knife 1 in order to hold the respective snip by means of suction effect through a predetermined angle range of the rotation of a suction roller on the same. In the embodiment represented in FIG. 1 of the foil knife 1 according to the invention two suction air through-passages 71a or 71b are respectively disposed in the snips areas 7a and 7b while in the snips area 8a and 8b respectively four suction air through-passages 81a or 81b are disposed.

According to the invention the suction air through-passages 71a, 71b, 81a and 81b are surrounded in the represented embodiment respectively by one bar-shaped plateau area 9, as it can be clearly discerned in FIG. 3.

In that area of the foil knife 1 that faces the interior area of the envelope blank 4, the base plate 6 of the foil knife features furthermore a large number of suction air through-passages 10 in order to hold the blank 4 by means of suction effect through a predetermined angle range during the rotation of the suction roller to the same.

The suction air through-passages 10 in the interior of the envelope blank 4 feature as present no plateau areas that surround them. Rather the suction air through-passages 10 are essentially flush with the upper side of the base plate 6 of the foil knife 1 in the interior area of the envelope blank 4.

FIG. 2 presents a schematic partial view of a further embodiment of a foil knife 1 according to the invention. In this case, besides the foil knife 1, the associated suction roller 20 is also represented against whose suction area 21 the foil knife 1 abuts.

The surface area 21 of the suction roller 20 features in this case a plurality of suction holes 22 that can be impinged with vacuum by known means. In this case during operation of the suction holes represented in FIG. 2, during utilization of the represented foil knife 1, only those suction holes 23 are impinged with vacuum that are designated by means of a double border that are located in the area of the suction air through-passage 71a of the foil knife 1.

The embodiment of the foil knife 1 according to the invention represented in FIG. 2 features, in contrast to the embodiment shown in FIG. 2, in the snips area 7a only a single suction air through-passage 71a.

This suction air through-passage 71a is completely surrounded by a continuous plateau area 9. Due to the active suction holes 23 located within the suction air through-passages 71a as well as the plateau area 9 a suction chamber is formed within the area encompassed by the plateau area 9, across whose entire dimensions the snip can then be held by means of vacuum.

In the embodiment forms represented in FIGS. 1 and 2 of the foil knife 1 according to the invention the plateau area 9 joins essentially directly to the edges of the respective suction air through-passage 71a, 71b, 81a, 81b, meaning it is not spaced apart from these.

In FIG. 3 a schematic cross sectional partial view of an embodiment of the foil knife 1 according to the invention with an envelope blank 4 disposed thereon is displayed. The base plate 6 of the foil knife features hereby a thickness D.

By means of the blade 5a a snip 11 is hereby detached from the envelope blank 4. The blade 5a hereby features a form that corresponds essentially to an equilateral triangle and projects from the surface of the base plate 6 with a height H. The form of the blade 5a represented in the figures and corresponding essentially to an equilateral triangle is to be regarded hereby only as a non-limiting example. Of course other blade cross section forms are hereby also conceivable, such as isosceles triangles, irregular triangles and other suitable geometric forms.

Spaced apart from the blade 5a the foil knife 1 features in the snips area 7a that is facing the snip 11 a suction air through-passage 71a. This suction air through-passage 71a is surrounded in a circumferentially complete manner by a plateau area 9 that here also is implemented bar-like and features a form, analogous to the blade 5a, that corresponds essentially to an equilateral triangle. However the height h, with which the plateau area 9 projects from the surface of the base plate 6, is less by the thickness d of the envelope blank 4 and consequently of the snip 11 than the height H of the blade 5a. By these means the snip 11 can abut against the plateau area 9 without having to be lowered out of the plane of the envelope blank 4.

By means of the suction effect provided by the area surrounded by the plateau area 9 due to the suction air through-passage 6 the snip 11 is pulled in a reinforced manner against the upper edge 9a of the plateau area 9. Because the upper edge 9a is in the example at hand implemented in a cutting edge like manner, by means of a minor intrusion of the upper edge 9a of the plateau area 9 into the snip 11 a particular good seal of the suction chamber in the area surrounded by the plateau area 9 can be achieved so that particular little infiltrated air is drawn in.

In all represented embodiments all plateau areas feature the same height throughout.

### LIST OF REFERENCE SYMBOLS

1 Foil knife

2 Front end of 1

3 Passage openings

4 Envelope blank

5a-5d Blades

6 Base plate of 1

7a, 7b Snips areas

8a, 8b Snips areas

71a, 71b Suction air through-passages

81a, 81b Suction air through-passages

9 Plateau area

9a Upper edge of 9

10 Suction air through-passages

11 Snips

20 Suction roller

21 Surface area of 20

22 Suction holes

23 “active” suction holes

D Thickness of 6

H Height 5a above 6

h Height 9 above 6

d Thickness of 4

1. A foil knife for utilization on a surface area of a suction roller, comprising:
at least one blade and a base plate with a surface that features in a snips area, which faces a snip detached during a cutting process from a useful part of a sheet material, at least one suction air through-passage for holding the snip by means of a suction effect through a predetermined angle range of a rotation of a suction roller on the same,
wherein the foil knife features around the suction air through-passage at least one plateau area in which the foil knife is elevated, at least section wise, relative to the thickness of the base plate by a height, as measured from the surface of the base plate, wherein the height is smaller than the height, measured from the surface of the base plate, of the blade of the foil knife.

2. The foil knife according to claim 1,
wherein the plateau area completely surrounds the suction air through-passage.

3. The foil knife according to claim 1,
wherein the foil knife is implemented in the plateau area, in a continuous manner, elevated by a height measured from the surface of the base plate.

4. The foil knife according to claim 1,
wherein the plateau area is at least section wise spaced apart from the suction air through-passage.

5. The foil knife according to claim 1,
wherein the plateau area is implemented as a bar.

6. The foil knife according to claim 1,
wherein the plateau area features, on its side facing away from the base plate, at least section wise one plateau area blade.

7. The foil knife according to claim 6,
wherein the height of the plateau area blade, measured from the surface of the base plate of the foil knife, is at least section wise smaller than the height of the blade measured from the surface of the base plate of the foil knife.

8. The foil knife according to claim 1,
wherein the difference between the height of the blade and the height of the plateau area corresponds substantially to the thickness of the sheet material to be cut.

9. The foil knife according to claim 1,
wherein a plurality of suction air through-passages are provided in the snips area, and disposed around each suction air through-passage is a plateau area.

10. The foil knife according to claim 1,
wherein a plurality of suction air through-passages are provided in the snips area, of which at least two are surrounded by a common plateau area.

11. The foil knife according to claim 10,
wherein the common plateau area completely surrounds each of the suction air through-passages.

12. The foil knife according to claim 1,
wherein the plateau area extends at least section wise up to the blade that detaches the snip from the useful part of the sheet material.

13. The foil knife according to claim 1,
wherein the outer contour of the plateau area corresponds substantially to the outer contour of the snip.

14. The foil knife according to claim 2,
wherein the foil knife is implemented in the plateau area, in a continuous manner, elevated by a height measured from the surface of the base plate.
